(19) United States
(12) Patent Application Publication
(10) Pub. No.: US 2023/0249698 A1
(43) Pub. Date: Aug. 10, 2023

(54) CONTROL APPARATUS

(71) Applicant: Mitsubishi Electric Corporation, Tokyo (JP)

(72) Inventors: Tomokazu SAITO, Tokyo (JP); Koji SHIMAMURA, Tokyo (JP)

(73) Assignee: Mitsubishi Electric Corporation, Tokyo (JP)

(21) Appl. No.: 18/012,796

(22) PCT Filed: Nov. 19, 2020
(86) PCT No.: PCT/JP2020/043157

§ 371 Date: Dec. 23, 2022

(51) Int. Cl. B60W 50/02

(52) U.S. Cl. CPC B60W 50/0205; B60W 2050/021

(57) ABSTRACT

There is provided a control apparatus having two or more control units that are connected with one another through a communication path; each of the control units has a switching processing section that selects the control unit that is made to continue the operation of software for the control unit in which an abnormality has been detected, based on an operational requirement for software in which an abnormality has been detected and the security state and control state of the control unit other than the control unit in which the abnormality has been detected.

### TECHNICAL FIELD

The present disclosure relates to a control apparatus.

### BACKGROUND ART

Two or more electronic control units referred to as ECUs (Electronic Control Units) are mounted in a vehicle; there is configured a control apparatus in which the respective ECUs are connected with each other through a vehicle network and operate in collaboration with two or more control units. Accordingly, there is a probability that due to a security attack through the vehicle network, a different thing illegally invades in the vehicle network so as to impersonate the control unit or to tamper with a program and hence a defect occurs in traveling control of the vehicle.

Meanwhile, to date, there has been a technology in which reduction of the vehicle functions, switching of the operation, or the like is performed in order to make the control apparatus operate with minimally necessary functions for the vehicle to travel even when an abnormality occurs in a control unit.

Patent Document 1 discloses a control apparatus in which when an abnormality occurs in the computing device of a control unit, software for reconfiguring a function related to the operation of the control unit having the abnormality is read out from a storage section and the memory area of another control unit is overwritten with the software. In Patent Document 1, the control apparatus is configured in such a way that when an abnormality occurs in a control unit, first-priority information set for software items is referred to, and then the memory area of a control unit storing software for which lower priority is set in the first-priority information is overwritten with software for reconfiguring a function related to the operation of the monitoring-subject control unit.

### PRIOR ART REFERENCE

### Patent Document

[Patent Document 1] Japanese Patent Application Laid-Open No. 2020-8950

### DISCLOSURE OF THE INVENTION

### Problems to be Solved by the Invention

However, in the conventional control apparatus disclosed in Patent Document 1, when the memory area of another control unit is overwritten with the software for reconfiguring a function related to the operation of a monitoring-subject control unit, the security state of the control unit, which is the overwriting destination of the software, is not taken into consideration. Accordingly, in the case where the control unit, which is the overwriting destination of the software, has no effective security measures for impersonation by a different thing, tampering, and the like, the control unit may undergo a security attack and may perform incorrect operation such as outputting an incorrect output value. Moreover, in the conventional control apparatus disclosed in Patent Document 1, the control state of the control unit, which is the overwriting destination of the software, is not considered; therefore, when a control unit that does not satisfy the operational requirement for the software is overwritten with the software, the software may not perform predetermined operation.

The present disclosure is to disclose a technology for solving the foregoing problems; the objective thereof is to provide a control apparatus that can make another control unit continue, as specified, the predetermined operation of a control unit having an abnormality.

### Means for Solving the Problems

A control apparatus disclosed in the present disclosure includes two or more control units that are connected with one another so as to be able to communicate with one another through a communication path; when an abnormality is detected in any one of the two or more control units, another control unit other than the control unit in which the abnormality has been detected is made to continue at least part of functions of software for the control unit in which the abnormality has been detected. The control apparatus is characterized in that each of the two or more control units has

a communication section that performs transmission and reception of a message with another control unit through the communication path,

a detection section that detects an abnormality in another control unit, based on a message that has been received by the communication section from said another control unit,

a management section that manages a security state and a control state of the control unit to which the management section itself belongs,

a determination section that determines whether or not when the detection section detects an abnormality in said another control unit, there exists necessity of making another control unit other than said another control unit in which the abnormality has been detected continue at least part of the functions of the software to be executed by said another control unit in which the abnormality has been detected, and

a switching processing section that selects the control unit that is made to continue at least part of the functions of the software, based on at least one of an operational requirement for the software for said another control unit in which the abnormality has been detected and the security state and the control state of another control unit other than said another control unit in which the abnormality has been detected, when the determination section determines that the necessity of continuance exists.

### Advantage of the Invention

The present disclosure makes it possible to obtain a control apparatus that can make another control unit continue, as specified, the predetermined operation of a control unit having an abnormality.

### BRIEF DESCRIPTION OF THE DRAWINGS

FIG. 1 is a block diagram representing the configuration of a control apparatus according to Embodiment 1;

FIG. 2A is a flowchart representing the operation of the control apparatus according to Embodiment 1;

FIG. 2B is a flowchart representing control-unit selection processing in the control apparatus according to Embodiment 1;

FIG. 3 is an explanatory table representing the configuration of data in a storage section of a storage apparatus in the control apparatus according to Embodiment 1;

FIG. 4A is an explanatory diagram representing the configuration of a message data frame in the control apparatus according to Embodiment 1;

FIG. 4B is an explanatory diagram representing an example of an abnormality message in the control apparatus according to Embodiment 1;

FIG. 5 is an explanatory table representing the configuration of data in a management section of the control unit in the control apparatus according to Embodiment 1;

FIG. 6 is a block diagram representing the configuration of a control apparatus according to Embodiment 3;

FIG. 7A is a flowchart representing the operation of the control apparatus according to Embodiment 3;

FIG. 7B is a flowchart representing software-switching processing in the control apparatus according to Embodiment 3; and

FIG. 8 is an explanatory table representing an example of a vehicle information item indicating the state of vehicle surrounding environment in the control apparatus according to Embodiment 3.

### BEST MODE FOR CARRYING OUT THE INVENTION

### Embodiment 1

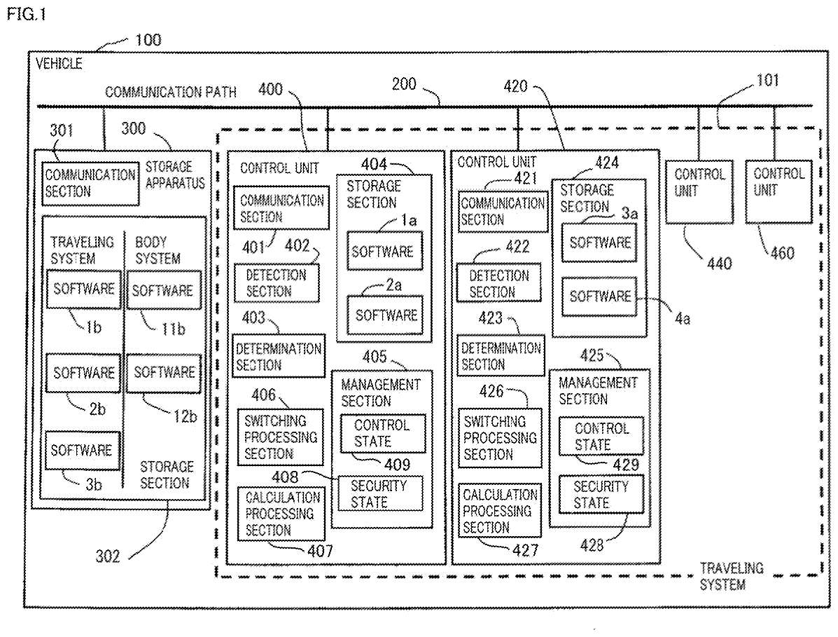

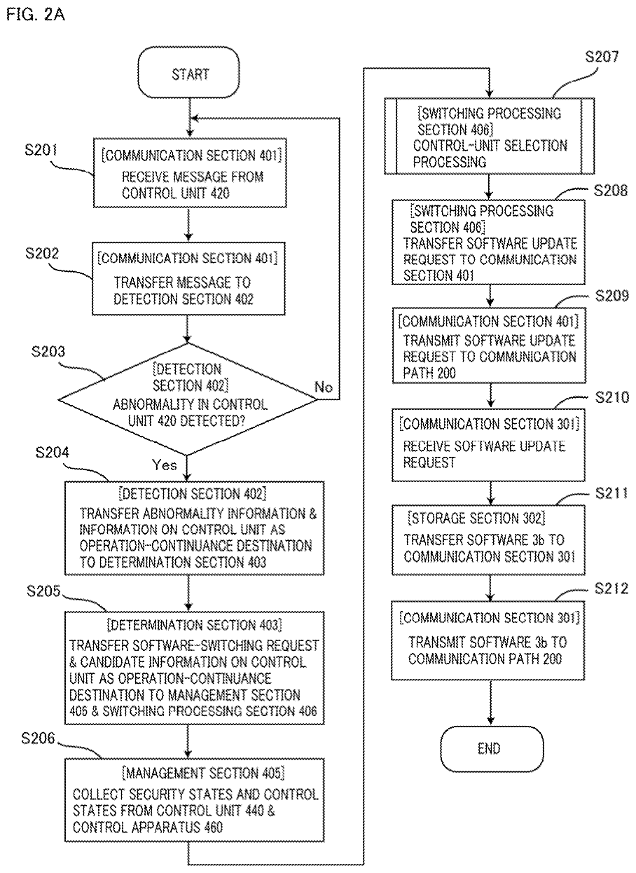

Hereinafter, a control apparatus according to Embodiment 1 will be explained based on the drawings. FIG. 1 is a block diagram representing the configuration of the control apparatus according to Embodiment 1. In FIG. 1, the control apparatus mounted in a vehicle 100 has a storage apparatus 300, a first control unit 400, a second control unit 420, a third control unit 440, and a fourth control unit 460. The first control unit 400, the second control unit 420, the third control unit 440, and the fourth control unit 460 belong to a group of a travelling system 101 of the vehicle 100 and have respective CPUs (Central Processing Units); for example, as an engine control unit, a steering control unit, and the like, the foregoing control units perform respective different control items.

The storage apparatus 300, the first control unit 400, the second control unit 420, the third control unit 440, and the fourth control unit 460 are connected with a communication path 200 configured with a CAN (Controller Area Network), can communicate with one another thorough the communication path 200, and can communicate also with other unillustrated control units.

A calculation processing section 407 is provided in the first control unit 400, and a calculation processing section 427 is provided in the second control unit 420. In addition, the same calculation processing section (unillustrated) is provided also in each of the third control unit 440 and the fourth control unit 460. Each of the calculation processing sections 407 and 427 can control a system and various kinds of apparatuses provided in the vehicle 100, by executing software possessed by the control unit to which it belongs.

Any one, of the first control unit 400, the second control unit 420, the third control unit 440, and the fourth control unit 460, that first receives a message (hereinafter, referred to as an abnormality message) including the contents of an abnormality in any of the foregoing control units transmits a response message to the communication path 200, so that it is prevented that the control unit other than the control unit that has first received the abnormality message performs the same processing.

For example, when the first control unit 400 first receives an abnormality message from the second control unit 420, the first control unit 400 transmits a response message to the communication path 200 and applies after-mentioned processing to the received abnormality message; however, each of the third control unit 440 and the fourth control unit 460 that each receive the response message from the first control unit 400 applies no processing to the received message, even when receiving the abnormality message from the second control unit 420.

The first control unit 400 has a communication section 401, a detection section 402, a determination section 403, a storage section 404, a management section 405, a switching processing section 406, and the calculation processing section 407. The storage section 404 of the first control unit 400 stores software 1a and software 2a. The management section 405 manages a security state 408 and a control state 409 of the first control unit 400 to which the management section 405 itself belongs.

The second control unit 420 has a communication section 421, a detection section 422, a determination section 423, a storage section 424, a management section 425, a switching processing section 426, and the calculation processing section 427. The storage unit 424 of the second control unit 420 stores software 3a and software 4a. The management section 425 manages a security state 428 and a control state 429 of the second control unit 420 to which the management section 425 itself belongs.

Similarly, each of the third control unit 440 and the fourth control unit 460 has a communication section, a detection section, a determination section, a storage section, a management section, a switching processing section, and a calculation processing section (none of them is illustrated); each of the storage sections stores two or more software items. The management sections manage respective security states and respective control states of the third control unit 440 and the fourth control unit 460 to which the corresponding management sections themselves belong.

The storage apparatus 300 is provided with a communication section 301 and a storage section 302. Through the communication path 200, the communication section 301 performs transmission and reception of data among the first control unit 400, the second control unit 420, the third control unit 440, and the fourth control unit 460. The storage section 302 preliminarily stores respective software items to be executed by the first control unit 400, the second control unit 420, the third control unit 440, and the fourth control unit 460 and operational requirements for the respective software items.

For example, the storage section 302 stores software 3b obtained by degenerating the function of the software 3a for the second control unit 420; moreover, as the operational requirements for the software 3b, the control state and the security state are stored in an accompanying manner. The control state of the software 3b means, for example, that the clock of the CPU is 100 [MHz] and a free memory of 150 [KB] is required; the security state of the software 3b means, for example, that a key having an ID of “2000” stored in an HSM (Hardware Security Module) is required.

Moreover, the storage section 302 stores software 1b obtained by degenerating the function of the software 1a for the first control unit 400 and software 2b obtained by degenerating the function of the software 2a. Furthermore, as the operational requirements for each of the software items 1b and 2b, the control state and the security state that are similar to the foregoing ones are stored in an accompanying manner. In addition, the storage section 302 stores software (unillustrated) obtained by degenerating the function of the software 4a for the second control unit 420 and respective software items (unillustrated) obtained by degenerating the respective functions of the software items (unillustrated) for the third control unit 440 and the fourth control unit 460; the control state and the security state that are similar to the foregoing ones, as the operational requirements for each of the degenerate software items, are also stored in an accompanying manner.

Through the communication path 200, which is a CAN, the communication section 401 of the first control unit 400, the communication section 421 of the second control unit 420, the communication section (unillustrated) of the third control unit 440, and the communication section (unillustrated) of the fourth control unit 460, and the communication section 301 of the storage apparatus 300 perform transmission and reception of data among themselves.

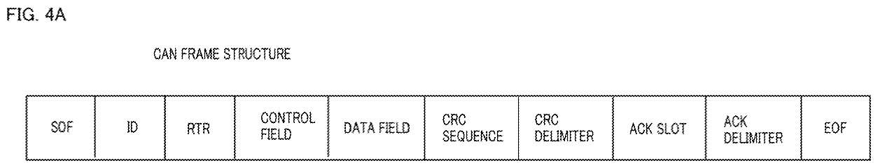

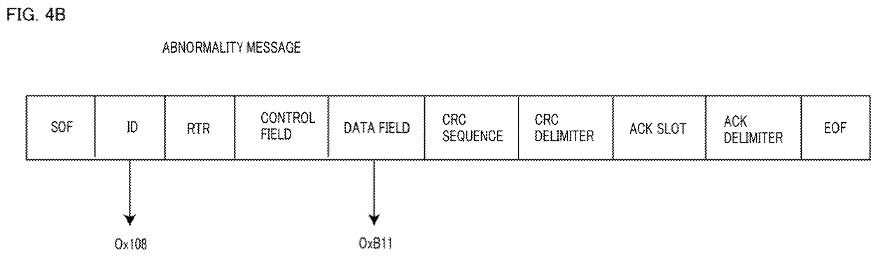

Next, the control apparatus according to Embodiment 1 will be explained in more detail. At first, the configuration of a message to be transmitted to the communication path 200, which is a CAN, will be explained. FIG. 4A is an explanatory diagram representing the configuration of a message data frame in the control apparatus according to Embodiment 1. As is well known, as represented in FIG. 4A, the structure of a CAN is configured with an SOF (Start of Frame), an ID (Identification Key), an RTR (Remote Transmission Request BIT), a Control Field, a CRC sequence (Cyclic Redundancy Check Sequence), a CRC delimiter (Cyclic Redundancy Check Delimiter), an ACK slot (Acknowledgement Slot), an ACK delimiter (Acknowledgement Delimiter), and an EOF (End of File).

In the following explanation, as an example, there will be explained the case where the first control unit 400 receives a message from the second control unit 420 through the communication path 200. In FIG. 1, when receiving the message from the second control unit 420, the communication section 401 of the first control unit 400 transfers the received message to the detection section 402. Based on the message received from the communication section 401, the detection section 402 determines whether or not an abnormality exists in the second control unit 420. When determining that the received message is abnormal, the detection section 402 transfers abnormality information on the second control unit 420 and information on the control apparatus as an operation-continuance destination to the determination section 403.

In this situation, there will be explained a configuration at a time when the message received by the first control unit 400 from the second control unit 420 is an abnormality message indicating an abnormality in the second control unit 420. FIG. 4B is an explanatory diagram representing an example of an abnormality message in the control apparatus according to Embodiment 1. In the case where the ID of the CAN frame is “0x108”, it is indicated that the contents of the data is abnormal and the priority is highest. In the case where the data field at a time when the ID is “0x108” is “0xB11”, it is indicated that the candidate of the operation-continuance destination for the software is in the group of the travelling system 101 and that the contents of the abnormality is related to a voltage abnormality in a brake sensor.

For example, when the ID of the message received by the communication section 401 from the second control unit 420 is “0x108” indicating an abnormality and the data field thereof is “0xB11”, the detection section 402 transfers the contents of the abnormality and candidate information on the control unit as the operation-continuance destination to the determination section 403. When receiving a message having an ID indicating an abnormality from the communication section 401, the detection section 402 preferentially performs processing of a message having a smaller-value ID and starts processing of a lower-priority message after ending the processing of the message having a smaller-value ID.

The determination section 403 receives the contents of the abnormality and candidate information on the control unit as the operation-continuance destination from the detection section 402 and then transfers the candidate information on the control unit as the operation-continuance destination along with a software-switching request signal to the management section 405 and the switching processing section 406. In this situation, the software-switching request signal means a signal that functions as a trigger for making each of the management section 405 and the switching processing section 406 start processing.

The storage section 404 stores software to be executed by the calculation processing section 407. The difference between the storage section 302 of the storage apparatus 300 and the storage section 404 of the first control unit 400 is that while the storage section 302 stores two or more software items to be executed by the respective calculation processing sections of the control units 400, 420, 440, and 460, the storage section 404 stores only software necessary for the first control unit 400 to perform control.

For example, the storage section 404 of the first control unit 400 stores the software items 1a and 2a for the first control unit 400 to control the steering apparatus of a vehicle; the storage section 302 of the storage apparatus 300 stores software items 1b, 2b, 3b, 11b, and 12b obtained by degenerating the respective functions of the software items for the control units 400, 420, 440, and 460. The software items 1b, 2b, and 3b belong to the group of the travelling system 101 of the vehicle 100; the software items 11b and 12b belong to a body system (unillustrated) of the vehicle 100.

The management section 405 manages the security state and the control state the first control unit 400 to which the management section 405 itself belongs. Similarly, each of the second control unit 420, the third control unit 440, and the fourth control unit 460 other than the first control unit 400 also manages its security state and control state by its management section.

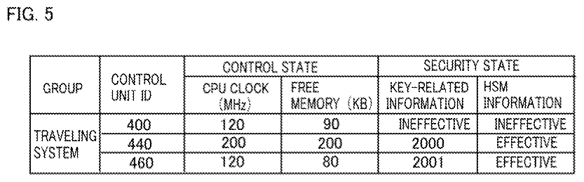

In this situation, there will specifically be explained the configuration of data that is for the security state and the control state of each of the control units and that is managed by the management section belonging to corresponding each of the control units. FIG. 5 is an explanatory table representing the configuration of data in the management section of the control unit in the control apparatus according to Embodiment 1. The example in FIG. 5 represents the respective security states and control states of the first control unit 400, the third control unit 440, and the fourth control unit 460 that each belong to the group of the travelling system 101. For example, it is represented that the first control unit 400 is in a control state that requires a CPU clock of 120 [MHz] and a free memory of 90 [KB] and in a security state that no key ID is possessed and the HSM is ineffective.

It is represented that the third control unit 440 is in a control state that requires a CPU clock of 200 [MHz] and a free memory of 200 [KB] and in a security state that the key ID is “2000” and the HSM is effective. In addition, it is represented that the fourth control unit 460 is in a control state that requires a CPU clock of 120 [MHz] and a free memory of 80 [KB] and in a security state that the key ID is “2001” and the HSM is effective.

When receiving the software-switching request signal from the determination section 403, the management section 405 of the first control unit 400 obtains, as described later, the foregoing control state and security state of the control unit other than the first control unit 400 to which the management section 405 itself belongs.

Next, as an example, there will specifically be explained a case where the management section 405 of the first control unit 400 obtains the control state and security state of the third control unit 440, which is the control unit other than the first control unit 400 to which the management section 405 itself belongs. For example, it is assumed that the candidate information on the control unit as the operation-continuance destination is that there exist the first control unit 400, the third control unit 440, and the fourth control unit 460 that each belong to the group of the travelling system 101. When receiving the software-switching request signal and the candidate information on the control unit as the operation-continuance destination from the determination section 403, the management section 405 starts to obtain the control state and the security state of the third control unit 440, based on the candidate information on the control unit as the operation-continuance destination.

At first, the management section 405 of the first control unit 400 creates a state request message and then transmits this state request message to the communication path 200 by way of the communication section 401. In this situation, in Embodiment 1, the state request message signifies a message at a time when the ID is “700”. Next, the communication section (unillustrated) of the third control unit 440 receives the state request message transmitted by the first control unit 400 and hence the foregoing communication section receives the security state and the control state of the third control unit 440 from the management section (unillustrated) of the third control unit 440 and then transmits the security state and the control state to the communication path 200.

As is the case with the third control unit, the communication section (unillustrated) of the fourth control unit 460 also receives the state request message transmitted by the first control unit 400 and hence the foregoing communication section receives the security state and the control state of the fourth control unit 460 from the management section (unillustrated) of the fourth control unit 460 and then transmits the security state and the control state to the communication path 200. At last, the communication section 401 of the first control unit 400 receives the security state and the control state of the third control unit 440, transmitted by the third control unit 440, and the security state and the control state of the fourth control unit 460, transmitted by the fourth control unit 460, and then transfers the foregoing received items to the management section 405.

The foregoing control state indicates the respective processing states of the control units 400, 420, 440, and 460 connected with the communication path 200 and is utilized as an element for the switching processing section 406 to select the control unit that is made to continue the operation. Selection of the control unit while considering the control state makes it possible to compare the present processing load of the control unit with the operational requirement for the software to be overwritten; thus, there can be obtained the effect that it is made possible to select the control unit that can run the overwritten software in accordance with the specification at a time of designing.

For example, the foregoing control state is indicated by the frequency of the CPU clock of the control unit and the memory usage rate. Specifically, the switching processing section 406 refers to the control state of the third control unit 440 with the management section 405, so that it can be obtained that the frequency of the CPU clock of the calculation processing section in the third control unit 440 is 200 [MHz] and the free memory is 200 [KB].

In addition, the foregoing security state indicates the respective security-function setting states of the control units 400, 420, 440, and 460 connected with the communication path 200 and is utilized as an element for the switching processing section 406 to select the control unit that is made to continue the operation, as is the case with the control state. Selection of the control unit while considering the security state makes it possible that software is executed by the control unit in which at least the security function required by each of the software items is mounted; therefore, there can be obtained the effect that it is made possible to select the control unit having a low risk of undergoing impersonation, tampering, or the like.

For example, as described above, the security state indicates the key ID possessed by the control unit and the effective state in the case where the control unit has an HSM. Specifically, the switching processing section 406 refers to the security state of the third control unit 440 with the management section 405, so that it can be obtained that in the third control unit 440, the key ID stored in the HSM has “2000”.

When receiving a software-switching request signal from the determination section 403, the switching processing section 406 selects the control unit, as the operation-continuance destination for the software 3a to be executed by the second control unit 420 that has been determined to have an abnormality.

Next, there will be explained the case where based on the foregoing control state and security state, there is selected the control unit that runs the software 3b obtained by degenerating the function of the software 3a for the second control unit 420. As described above, the software 3b is stored in the storage section 302 of the storage apparatus 300.

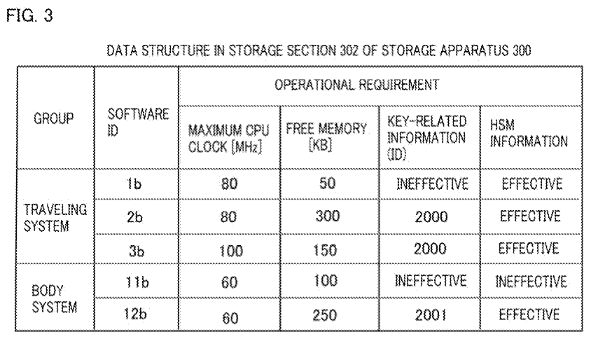

In this situation, there will be explained the data configuration stored in the storage section 302 of the storage apparatus 300. FIG. 3 is an explanatory table representing the configuration of data in the storage section of the storage apparatus in the control apparatus according to Embodiment 1. As described above, the storage section 302 of the storage apparatus 300 stores two or more software items obtained by degenerating the software items to be executed by the respective calculation processing sections of the control units 400, 420, 440, and 460. In the example represented in FIG. 3, the storage section 302 stores software items having software IDs 1b, 2b, and 3b, as the software items for the group of the travelling system 101, and software items having software IDs 11b and 12b, as the software items for the group of the body system.

In each of the software items, as the operational requirements, the CPU clock[MHz], the free memory[KB], the necessity (effective or ineffective) of an HSM, and the necessity of a key (the key ID, in the case where it is necessary) are related to the software ID. When the software information is obtained, the switching processing section 406 of the first control unit 400 inputs the software ID to the storage apparatus 30, so that the operational requirements for the software are outputted to the storage section 302.

For example, when the switching processing section 406 of the first control unit 400 transmits a message including the software ID “1b” to the storage apparatus 300, the switching processing section 406 can obtain the software data of the software ID “1b” and the information, as the operational requirements, that “the CPU clock is 80 [MHz], the free memory is 50 [KB], the HMS is necessary (effective), and the key ID is not necessary (ineffective)” from the storage section 302 of the storage apparatus 300.

In this situation, the explanation for the case where the control unit that runs the software 3b is selected will be resumed. At first, after receiving the software-switching request signal from the determination section 403, the switching processing section 406 of the first control unit 400 obtains the security state and the control state of the control unit in the group of the travelling system 101 from the management section 405, because the candidate information on the control unit as the operation-continuance destination is in the group of the travelling system 101 of the vehicle. Subsequently, the switching processing section 406 receives the operational requirements for the software 3b from the storage apparatus 300.

Next, based on the control state and the security state, the switching processing section 406 selects the control unit that runs the software 3b, among the control units in group of the travelling system 101. Specifically, the control unit that runs the software 3b is selected in the following manner.

At first, in the first selection, the switching processing section 406 compares the operational requirements for the software 3b with the operation state and security state of the first control unit 400. In this situation, at first, the CPU clocks are compared with each other. While in the operational requirements for the software 3b, the CPU clock is 100 [MHz], the CPU clock of the first control unit 400 is 120 [MHz]; thus, the requirement is satisfied. Next, the memories will be compares with each other. While in the operational requirements for the software 3b, a free memory of 150 [KB] is required, the free memory of the first control unit 400 is 90 [MHz]; thus, the requirement is not satisfied. Accordingly, because having an item that does not satisfy the requirement for the software 3b, the first control unit 400 is removed from the operation-continuance destinations. The switching processing section 406 moves to the next selection of the control unit, i.e., to the second selection.

In the second selection, the switching processing section 406 compares the operational requirements for the software 3b with the control state and security state of the third control unit 440. The comparation items are the same as those in the first selection. Comparing the CPU clocks, while the CPU clock for the software 3b is 100 [MHz], the CPU clock of the third control unit 440 is 200 [MHz]; thus, the requirement is satisfied. Next, comparing the memories, while the software 3b requires 150 [KB], the free memory of the third control unit 440 is 200 [KB]; thus, the requirement for the control unit as the operation-continuance destination is satisfied.

Next, comparing the HSM information items, while the software 3b requires that the HSM information be effective, the HSM information of the third control unit 440 is effective; thus, the requirement for the control unit as the operation-continuance destination is satisfied. At last, comparing the key-related information items, while the software 3b requires that the key ID stored in the HSM be 2000, the third control unit 440 has key ID of 2000 in the HSM; thus, the requirement for the control unit as the operation-continuance destination is satisfied. Accordingly, because the third control unit 440 satisfies all operational requirements for the software 3b, the switching processing section 406 determines that the third control unit 440 is the control unit as the operation-continuance destination. Because it has been determined in the second selection that the third control unit 440 is the control unit as the operation-continuance destination, the control unit 460 is also the selection subject; however, the third selection is not performed.

Next, the switching processing section 406 transfers a software update request to the communication section 401. In this situation, the software update request is a message for instructing the third control unit 440 to overwrite the storage section (unillustrated) of the third control unit 440 with software. The switching processing section 406 of the first control unit 400 transmits a message indicating a software update request for the software with the ID “780” and the data field “0x403” to the communication path 200 by way of the communication section 401.

The communication section 301 of the storage apparatus 300 receives the software update request via the communication path 200, and the storage section 302 transfers the software 3b to the communication section 301. Next, the communication section 301 transmits the software 3b to the communication path 200. The third control unit 440 receives the software update request transmitted by the first control unit 400. The third control unit 440 determines that the ID is for a software update request and the software update request has been transmitted to itself, and then overwrites the storage section of the third control unit 440 with the software 3b to be received next.

The calculation processing section 407 transmits the output values, which are results of execution of the software items 1a and 2a, so as to make the systems and apparatuses provided in the vehicle operate.

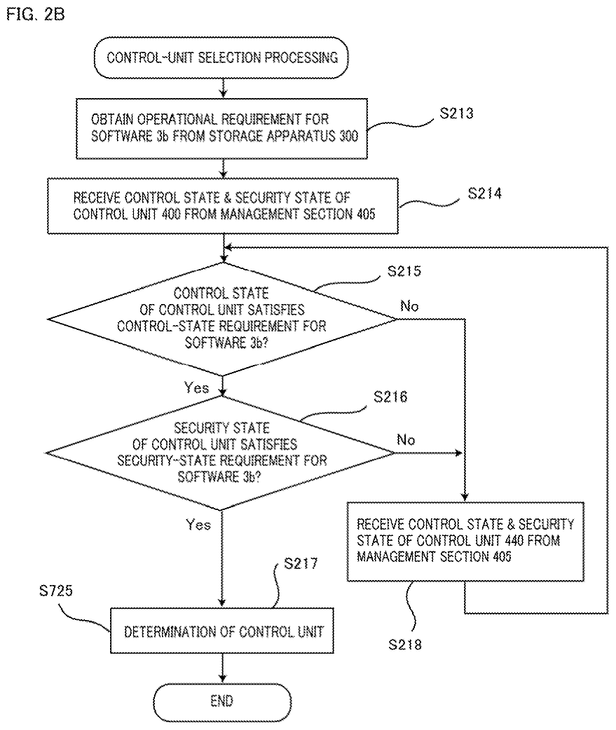

Next, the operation of the control apparatus according to Embodiment 1 will collectively be explained by use of flowcharts. FIG. 2A is a flowchart representing the operation of the control apparatus according to Embodiment 1. In FIG. 2A, in the step S201, the communication section 401 receives a message from the second control unit 420, through the communication path 200; in the step S202, the communication section 401 transfers the received message to the detection section 402 and then the step S202 is followed by the step S203.

In the step S203, based on the received message, the detection section 402 determines whether or not the second control unit 420 has an abnormality; in the case where it is determined that the second control unit 420 has an abnormality (Yes), the step S203 is followed by the step S204, where the detection section 402 transfers abnormality information and information on the control unit as the operation-continuance destination to the determination section 403. In the step S205, the determination section 403 transfers the software-switching request and the candidate information on the control unit as the operation-continuance destination to the management section 405 and the switching processing section 406; then, the step S205 is followed by the step S206.

In the step S206, the management section 405 collects the respective security states and control states from the third control unit 440 and the fourth control unit 460. Next, in the step S207, when receiving the software-switching request signal from the determination section 403, the switching processing section 406 selects the control unit, as the operation-continuance destination for the software 3a to be executed by the second control unit 420 that has been determined to have an abnormality, in such a manner as described above.

Next, in the step S208, the switching processing section 406 transfers the software update request to the communication section 401; in the step S209, the communication section 401 transmits the software update request to the communication path 200. In the step S210, the communication section 301 of the storage apparatus 300 receives the software update request; then, in the step S302, the storage section 302 transfers the degenerate software, obtained by degenerating the function of the software 3a for the second control unit 420 having an abnormality, to the communication section 301. In the step S212, the communication section 301 transmits the software 3b to the communication path 200.

FIG. 2B is a flowchart representing control-unit selection processing in the control apparatus according to Embodiment 1; the foregoing control-unit selection operation is collectively represented. In FIG. 2B, in the step S213, the first control unit 400 obtains the operational requirements for the software 3b from the storage apparatus 300. Next, in the step S214, the switching processing section 406 of the first control unit 400 receives the control state and security state of the first control unit 400 from the management section 405; then, the step S214 is followed by the step S215.

In the step S215, the switching processing section 406 determines whether or not the control state of the first control unit 400 to which the switching processing section 406 itself belongs satisfies the control-state requirement for the software 3b; in the case where the control state of the first control unit 400 satisfies the control-state requirement for the software 3b (Yes), the step S215 is followed by the step S216, where it is determined whether or not the security state of the first control unit 400 satisfies the security-state requirement for the software 3b. In the case where it is determined in the step S216 that the security state of the first control unit 400 satisfies the security-state requirement for the software 3b (Yes), the step S216 is followed by the step S217, where it is determined that the first control unit 400 is the control unit as the operation-continuance destination for the second control unit 420 having an abnormality.

In contrast, in the case where it is determined in the step S215 that the control state of the first control unit 440 does not satisfy the control-state requirement for the software 3b (No), the step S215 is followed by the step S218, where the switching processing section 406 receives the control state and security state of the third control unit 440 from the management section 405; then, the step S218 is followed by the step S215, where the switching processing section 406 determines whether or not the control state of the third control unit 440 satisfies the control-state requirement for the software 3b. In the case where it is determined that the control state of the third control unit 440 satisfies the control-state requirement for the software 3b (Yes), the step S215 is followed by the step S216, where it is determined whether or not the security state of the third control unit 440 satisfies the security-state requirement for the software 3b.

In the case where it is determined in the step S216 that the security state of the third control unit 440 satisfies the security-state requirement for the software 3b (Yes), the step S216 is followed by the step S217, where it is determined that the third control unit 440 is the control unit as the operation-continuance destination for the second control unit 420 having an abnormality.

In addition, in the case where it is determined in the step S216 that the security state of the third control unit 440 does not satisfy the security-state requirement for the software 3b (No), the step S216 is followed by the step S218, where the switching processing section 406 receives the control state and security state of the fourth control unit 460 from the management section 405; then, the step S218 is followed by the step S215, where the switching processing section 406 determines whether or not the control state of the fourth control unit 460 satisfies the control-state requirement for the software 3b. After that, by repeating processing items similar to the foregoing ones, the control unit, as the candidate, that satisfies the control-state requirement for the software 3b is selected and is determined to be the control unit as operation-continuance destination for the second control unit 420 having an abnormality.

In the foregoing control apparatus according to Embodiment 1, as the security state, whether or not a key ID, which is required in message authentication to be generally equipped as the measures for data tampering or impersonation, can be utilized and whether or not the key ID is stored in the HSM are utilized for selecting the control unit; however, the method of selecting the control unit is not limited thereto; for example, it may be allowed that whether or not as a tampering-detection function, a memory-monitoring function is possessed is utilized for selecting the control unit.

In the control apparatus according to Embodiment 1, because when the control unit undergoes a security attack, the vehicle cannot normally be controlled, the respective security-function setting sates of both the software and the control unit are ascertained. As described above, in the case where the software 3a to be executed by the second control unit 420 is equipped with a function for authenticating a message between the first control unit 400 and the second control unit 420, the key ID that has been utilized by the second control unit 420 for authenticating the message is required in the case where the control unit other than the second control unit 420 executes the software 3a or the software 3b.

In addition, in the control apparatus according to Embodiment 1, as the control state, the CPU clock frequency and the memory usage rate are utilized; however, there are some more methods; it may be allowed that the priority of the software and the degeneration state of the software are included.

Moreover, in the control apparatus according to Embodiment 1, the candidate of the control unit as the operation-continuance destination is the control unit belonging to the same functional group; however, there are some more methods; it may be allowed that the control units are classified based on the respective ASILs (Automotive Safety Integrity Levels) thereof and the ASILs are utilized.

Furthermore, in the control apparatus according to Embodiment 1, the storage section 302 of the storage apparatus 300 stores software items obtained by degenerating the software items possessed by the respective storage sections of the control units; however, it may be allowed that the storage section 302 stores software items that have not been degenerated.

Moreover, in the control apparatus according to Embodiment 1, the storage apparatus 300 is provided in the vehicle 100; however, there are some more methods; it may be allowed that the storage apparatus 300 is provided outside the vehicle and performs wireless communication with the vehicle.

Furthermore, in the control apparatus according to Embodiment 1, the communication path 200 is configured with a CAN; however, another network such as a CANFD (CAN with Flexible Data Rate), a LIN (Local Interconnect Network), or a Flex Ray may be utilized.

### Embodiment 2

Next, a control apparatus according to Embodiment 2 will be explained. The configuration of the control apparatus according to Embodiment 2 is the same as that of the control apparatus according to Embodiment 1 represented in FIG. 1. Hereinafter, with regard to the control apparatus according to Embodiment 2, the point different from Embodiment 1 will mainly be explained. The different point between the control apparatus according to Embodiment 2 and the control apparatus according to Embodiment 1 is that the series processing from detection that the second control unit 420 has an abnormality to selection of the control unit as the operation-continuance destination is performed by the second control unit 420 itself. That is to say, the different point between the control apparatus according to Embodiment 2 and the control apparatus according to Embodiment 1 is that in the control apparatus according to Embodiment 2, the series processing from detection that a control unit has an abnormality to selection of another control unit as the operation-continuance destination is performed by the foregoing control unit itself.

In the foregoing control apparatus according to Embodiment 1, for example, the first control unit 400 receives a message from the second control unit 420 so that an abnormality in the second control unit 420 is detected; however, in the control apparatus according to Embodiment 2, for example, the second control unit 420 detects its own abnormality. As a method in which the detection section 422 of the second control unit 420 detects an abnormality in the second control unit 420 itself, for example, in the case where the output value of the software 3a is deviated from a normal value, the detection section 422 detect that an abnormality has occurred in the software 3a for the second control unit 420.

In the operation after the detection section 422 detects that an abnormality has occurred in the software 3a for the second control unit 420, the operation from the step where the determination section 423 determines whether or not operation is to be continued to the step where a software update request is transmitted to the third control unit 440 is the same as the operation by the control apparatus according to Embodiment 1. The control apparatus according to Embodiment 2 can demonstrate an effect the same as that of the control apparatus according to Embodiment 1.

### Embodiment 3

Next, a control apparatus according to Embodiment 3 will be explained. In the case of the traveling system of a vehicle, two or more control units can be grouped with regard to two or more functions such as the steering apparatus and the braking apparatus; in the case of the body system of a vehicle, two or more control units can be grouped with regard to two or more functions such as the head light and the wiper. In the control apparatus according to Embodiment 3, two or more control units are classified into several groups for respective preliminarily determined functions; the control units are managed in each of the groups so as to perform control.

In the control apparatus according to Embodiment 3, for example, the first control unit periodically obtains respective security states, respective control states, and respective software-execution states from two or more other control units that are managed by the first control unit; the first control unit detects an abnormality in another control unit under its management, and then performs operation-continuance processing for the control unit in which the abnormality has been detected.

In the control apparatus according to Embodiment 3, there exist two points in each of which the first control unit is different from that in Embodiment 1 represented in FIG. 1. The first different point is that while in the first control apparatus according to Embodiment 1, the storage section of the storage apparatus is provided outside the control unit, the storage section is provided inside the control unit in the control apparatus according to Embodiment 3. The second different point is that in the control apparatus according to Embodiment 3, the management section of the control unit manages a vehicle state. Hereinafter, with regard to the control apparatus according to Embodiment 3, the point different from the control apparatus according to Embodiment 1 will mainly be explained.

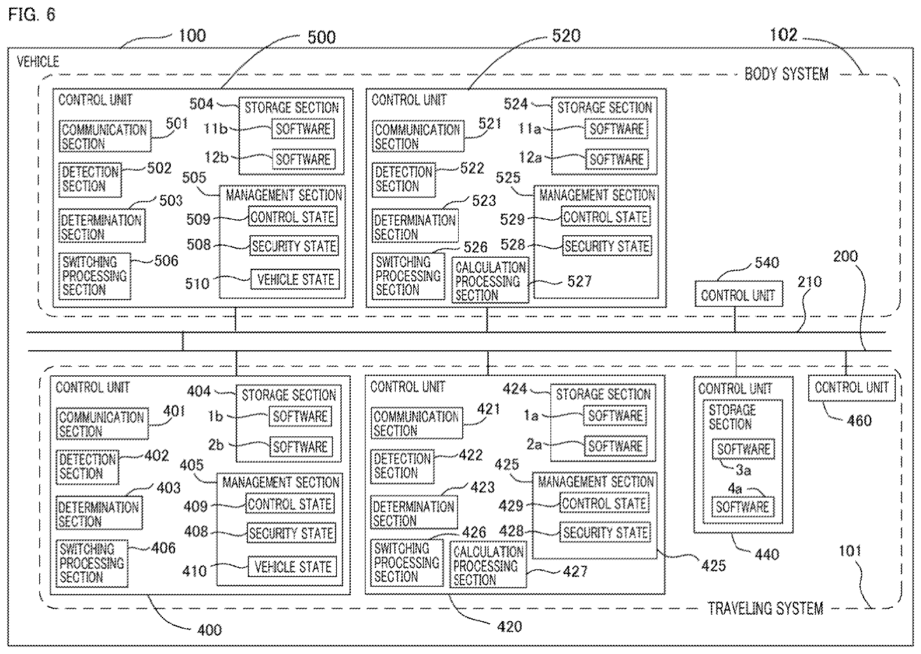

FIG. 6 is a block diagram representing the configuration of the control apparatus according to Embodiment 3. In FIG. 6, each time periodically obtaining vehicle states 410 and 510, various kinds of sensors (unillustrated) provided in the vehicle 100 transmit the vehicle states 410 and 510 to the communication path 200 and a communication path 210, which are CANs. The communication path 200 and the communication path 210 are connected with each other. Each of the control units provided in the vehicle 100 periodically transmits the control state and security state possessed by its own management section to the communication path 200 and the communication path 210.

The first control unit 400, the second control unit 420, the third control unit 440, and the fourth control unit 460 are connected with the communication path 200, which is a CAN; the fifth control unit 500, the sixth control unit 520, and the seventh control unit 540 are connected with the communication path 210, which is a CAN. In addition, the fifth control unit 500 has a communication section 501, a detection section 502, a determination section 503, a switching processing section 506, a storage section 504, and a management section 505; the sixth control unit 520 has a communication section 521, a detection section 522, a determination section 523, a switching processing section 526, a calculation processing section 527, a storage section 524, and a management section 525. The storage section 504 is provided with software 11b and software 12b. The storage section 524 is provided with software 11a and software 12b. The software 11b and the software 12b are the software items obtained by degenerating the software 11a and the software 12b, respectively.

The management section 505 has a control state 509, a security state 508, and a vehicle state 510; the management section 525 has a control state 529 and a security state 528. Each of the second control unit 420, the third control unit 440, and the fourth control unit 460 belongs to the traveling system 101 of the vehicle 100 and controls the steering system, the braking system, and the like. Each of the sixth control unit 520 and the seventh control unit 540 belongs to the body system 102 of the vehicle 100 and controls the headlight, the wiper, and the like. The respective configurations and the respective functions of the sixth control unit 520 and the seventh control unit 540 are the same as those of the second control unit 420, the third control unit 440, and the fourth control unit 460. The first control unit 400 manages the control state, the security state, and the software-execution state of each of the second control unit 420, the third control unit 440, and the fourth control unit 460 that belong to the group of the travelling system 101. The vehicle 100 is provided with only one control unit, for each of the function groups, that has a function the same as that of the first control unit 400. In the present embodiment, the fifth control unit 500 belongs to the group of the body system 102, has a function the same as that of the first control unit 400, and manages the respective control states, the respective security states, and the respective software-execution states of the sixth control unit 520 and the seventh control unit 540 that belong to the body system 102.

The detection section 402 analyses the obtainment state and the contents of a message from the second control unit 420 that has been received by the communication section 401; in the case where the obtained message includes the normal security state 428 and the normal control state 429 of the second control unit 420, the detection section 402 transfers the message from the second control unit 420 to the management section 405; in other cases, the detection section 402 detects whether or not an abnormality has occurred in the second control unit 420. For example, when the detection section 402 cannot receive a message including the output result of the software 2a for the second control unit 420, within 10 [ms] of the immediately previous reception, the detection section 402 determines that an abnormality has occurred in the second control unit 420 and then transfers the contents of the abnormality to the determination section 403.

Based on the abnormality contents received from the detection section 402, the determination section 403 determines whether or not the operation of the software 2a for the second control unit 420 needs to be continued by the control unit other than the second control unit 420. In this situation, provided that the abnormality contents received by the determination section 403 from the detection section 402 is that “the detection section 402 could not receive a message including the output result of the software 2a for the second control unit 420, within 10 [ms] of the immediately previous reception”, the determination section 403 determines that the software 2a needs to be operated by another control unit, when receiving abnormality contents the same as the foregoing abnormality contents from the detection section 402 five times continuously. In the case where the determination section 403 determines that the software 2a needs to be operated by another control unit, the determination section 403 transfers the software-switching request signal to the switching processing section 406.

The storage section 404 stores software items obtained by degenerating the respective software items to be executed by the control units 424, 440, and 460 in the group of the travelling system 101 to be managed by the first control unit 400. In FIG. 6, there are described only the software items 1b and 2b, as the software items obtained by degenerating the software items 1a and 2a, respectively, stored in the storage section 424 of the second control unit 420.

The management section 405 manages the vehicle state 410 of the vehicle 100 and the respective control states and security states of the second control unit 420, the third control unit 440, and the fourth control unit 460, which have been received by the communication section 401. In this situation, the vehicle state 410 means a real time state of the surroundings of the vehicle 100; for example, the vehicle state 410 indicates whether the traveling state is a high-speed running state, a low-speed running state, or a stoppage state, whether the surrounding state is day or night, or whether or not the traffic states is jammed. Specifically, these vehicle states 410 make it possible to comprehend the fact, for example, that the vehicle 100 is in a low-speed running state, the surrounding state is day, and the traffic is jammed.

The switching processing section 406 analyses the foregoing vehicle state 410 so as to determine a candidate group to which the control unit as the operation-continuance destination belongs; then, the switching processing section 406 performs processing for selecting the control unit that belongs to the determined group. Specifically, at first, the switching processing section 406 receives the software-switching request signal and then determines the candidate control unit that belongs to the functional group of the control units that are made to continue the operation of the software 1b, which is software obtained by degenerating the software 1a based on the vehicle state 410 possessed by the management section 405. For example, the vehicle state 410 is “low-speed running, day time, and jammed”, the control unit belonging to the body system 102 is determined to be the candidate.

Next, the switching processing section 406 ascertains whether or not the management section 405 has the respective control states and security states of the sixth control unit 520 and the seventh control unit 540, which are the control units belonging to the group of the body system 102; in the case where the management section 405 has the respective control states and security states of the sixth control unit 520 and the seventh control unit 540, the switching processing section 406 moves to control-unit selection processing; in the case where the management section 405 does not have the respective control states and security states of the sixth control unit 520 and the seventh control unit 540, the switching processing section 406 transmits the state request message to the fifth control unit 500 so as to collect the respective control states and security states of the sixth control unit 520 and the seventh control unit 540 from the fifth control unit 500. The processing related to selection of the control unit that is made to continue the operation of the software 1b is the same as the foregoing processing in Embodiment 1.

In the case where as a result of selection of the control unit that is made to continue the operation of the software 1b, the seventh control unit 540 is determined to be the control unit as the operation-continuance destination for the software 1b, the first control unit 400 transmits the software update request and data of the software 1b to the fifth control unit 500. Based on the software update request, the fifth control unit 500 starts to overwrite the storage section 524 of the seventh control unit 540 with the software 1b.

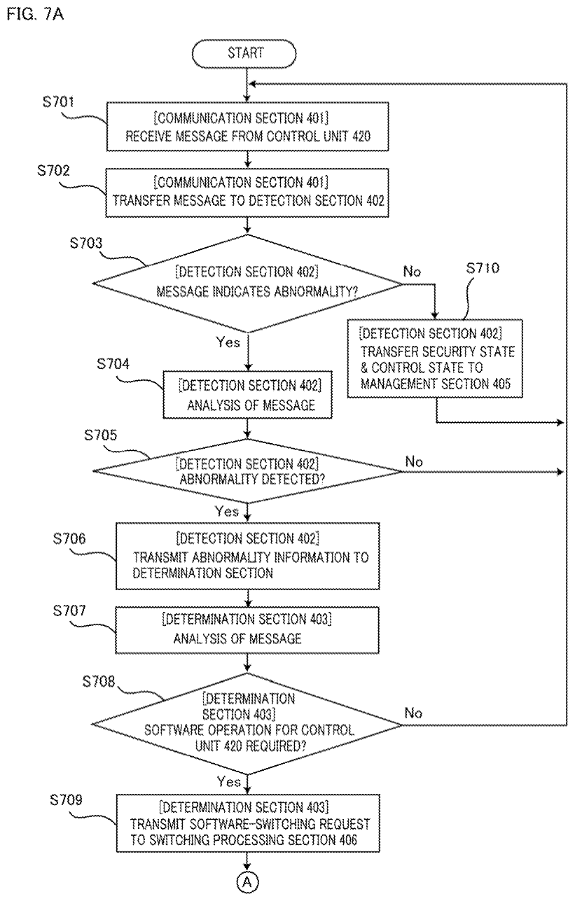

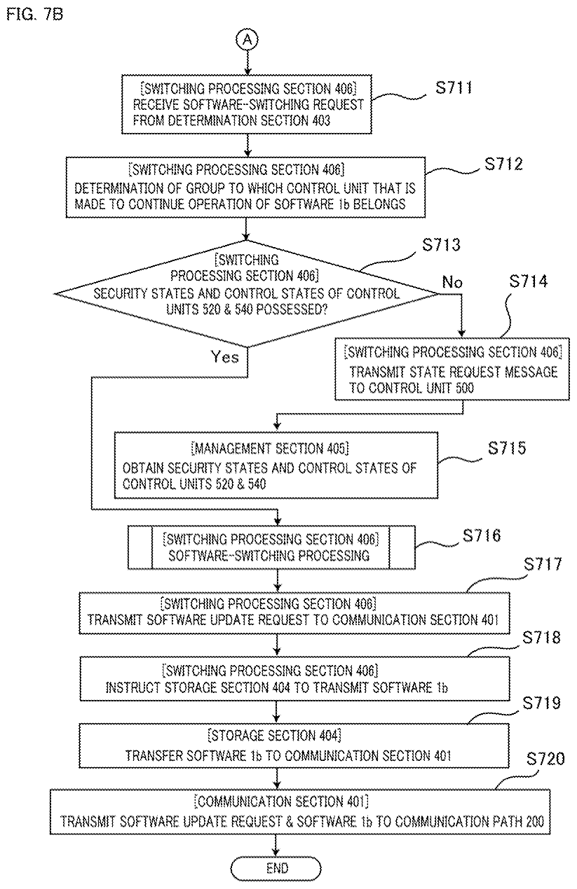

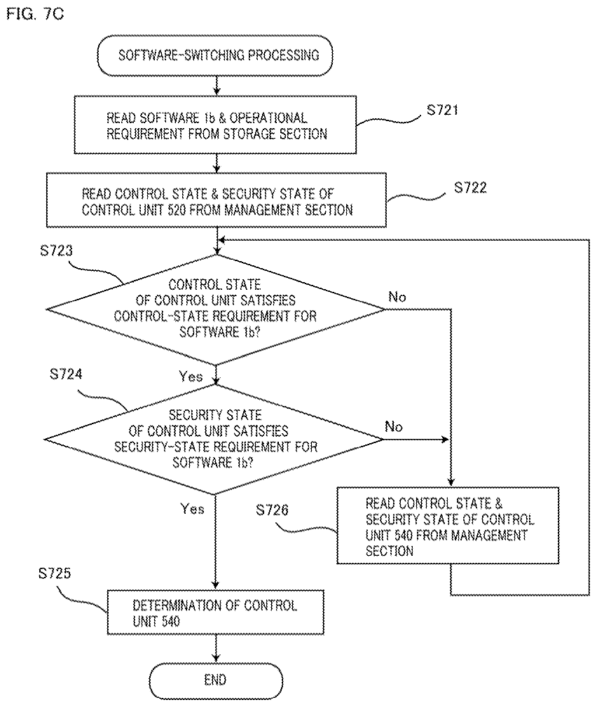

Next, the operation of the control apparatus according to Embodiment 3 will be explained based on a flowchart. FIG. 7A is a flowchart representing the operation of the control apparatus according to Embodiment 3; FIG. 7B is a flowchart representing software-switching processing in the control apparatus according to Embodiment 3; an example of the operation is collectively represented.

In FIG. 7A, in the step S701, the communication section 401 of the first control unit 400 receives a message from the second control unit 420. In the step S702, the communication section 401 transfers the received message to the detection section 402. Next, in the step S703, the detection section 402 determines whether or not the received message indicates an abnormality; in the case where the received message indicates an abnormality (Yes), the step S703 is followed by the step S704; in the case where the received message does not indicate any abnormality (No), the step S703 is followed by the step S710. In the step S710, the detection section 402 transfers the security state and control state of the second control unit 420 to the management section 405; then, the step S701 is resumed.

In contrast, in the step S704 following the step S703, the detection section 402 analyses the message; then, in the step S705, based on the received message, the detection section 402 determines whether or not an abnormality in the second control unit 420 has been detected; in the case where it is determined that an abnormality has been detected (Yes), the step S705 is followed by the step S706; in the case where it is determined that no abnormality has been detected (No), the step S701 is resumed.

In the step S706 following the step S705, the detection section 402 transmits the message including abnormality information on the second control unit 420 to the determination section 403; then, the step S706 is followed by the step S707. In the step S707, the determination section 403 analyses the transmitted message; then, in the step S708, the determination section 403 determines whether or not it is required to continue the operation of the software for the second control unit 420; in the case where it is determined that it is not required to continue the operation (No), the step S701 is resumed; in the case where it is determined that it is required to continue the operation (Yes), the step S708 is followed by the step S709.

In the step S709, the determination section 403 transmits a software switching request to the switching processing section 406; then, the step S709 is followed by the step S711. In the step S711, the switching processing section 406 receives the software switching request from the determination section 403; then, in the step S712, the switching processing section 406 starts operation for determining the group of the control units, to which the control unit that is made to continue the operation of the software 1b belongs; as described above, for example, in the case where the vehicle state 410 is “low-speed running, day time, and jammed”, the control unit belonging to the body system 102 is determined to be the candidate.

Next, in the step S713, the switching processing section 406 determines whether or not the fifth control unit 500 among the control units belonging to the body system 102 has the respective control states and security states of the sixth control unit 520 and the seventh control unit 540; in the case where the fifth control unit 500 does not have the respective control states and security states of the sixth control unit 520 and the seventh control unit 540 (No), the step S713 is followed by the step S714, where the switching processing section 406 transmits a state request message to the fifth control unit 500. Next, in the step S715, the management section 405 obtains the respective control states and security states of the sixth control unit 520 and the seventh control unit 540; then, the step S715 is followed by the step S716. In contrast, in the case where it is determined in the step S713 that the fifth control unit 500 has the respective control states and security states of the sixth control unit 520 and the seventh control unit 540 (Yes), the step S713 is followed by the step S716.

In the step S716, the switching processing section 406 starts to execute the software-switching processing; in the step S717, the switching processing section 406 transmits the software update request to the communication section 401. Next, in the step S718, the switching processing section 406 instructs the storage section 404 to transmit the software 1b. In the step S719, the storage section 404 transmits the software 1b to the communication section 401; in the step S720, the communication section 401 transmits the software 1b and the software update request to the communication path 200, so that the storage section 504 of the fifth control unit 500 is overwritten with the software 1b.

Next, in FIG. 7B representing the software-switching processing, the switching processing section 506 of the fifth control unit 500 reads the software 1b and the operational requirement from the storage section 504; in the step S722, the switching processing section 506 reads the control state and the security state of the sixth control unit 520 from the management section 505. Next, in the step S723, the switching processing section 506 determines whether or not the control state of the sixth control unit 520 satisfies the control-state requirement for the software 1b; in the case where the control state of the sixth control unit 520 satisfies the control-state requirement for the software 1b (Yes), the step S723 is followed by the step S724; in the case where the control state of the sixth control unit 520 does not satisfy the control-state requirement for the software 1b (No), the step S723 is followed by the step S726.

In the step S724 following the step S723, the switching processing section 506 determines whether or not the security state of the sixth control unit 520 satisfies the security-state requirement for the software 1b; in the case where the security state of the sixth control unit 520 satisfies the security-state requirement for the software 1b (Yes), the step S724 is followed by the step S725, where the sixth control unit 520 is determined to be the control unit that is overwritten with the software 1b obtained by degenerating the software 1a for the second control unit 420 having an abnormality.

In contrast, in the case where after the determination in the step S723 or S724, the step S723 or S724 is followed by the step S726, the switching processing section 506 reads the control state and the security state of the seventh control unit 540 from the management section 505; then, the step S723 is resumed. In the step S723, the switching processing section 506 determines whether or not the control state of the seventh control unit 540 satisfies the control-state requirement for the software 1b; after that, the foregoing operation is repeated; then, in the step S725, the seventh control unit 540 is determined to be the control unit that is overwritten with the software 1b obtained by degenerating the software 1a for the second control unit 420 having an abnormality.

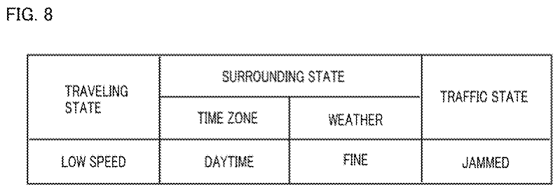

FIG. 8 is an explanatory table representing an example of a vehicle information item indicating the state of vehicle surrounding environment in the control apparatus according to Embodiment 3. In the example represented in FIG. 8, it is indicated that the vehicle 100 is running at low speed in the fine daytime and that the traffic is jammed. Selection of the control unit while considering the vehicle state 410 makes it possible to determine the candidate control unit, based on the elements that do not drastically change, unlike the weather, the traffic condition, and the like; thus, there can be obtained the effect that it is made possible to select the control unit that has margins for the processing load and the memory usage amount even after being overwritten with the software.

In addition, in the control apparatus according to Embodiment 3, it has been described that the sixth control unit 520 or the seventh control unit 540 continues the operation of the second control unit 420; however, there are some more methods; it may be allowed that the control unit such as the first control unit 400 or the fifth control unit 500, that manages the functional groups continues the operation of the second control unit 420.

In addition, each of the respective control apparatuses according to foregoing Embodiments may be configured in such a way that the switching processing section can select another control unit, among two or more control units, that is made to continue at least part of the software functions to be executed by the control unit to which the switching processing section itself belongs.

Moreover, the control apparatus according to each of foregoing Embodiments may be configured in such a way that two or more control units are mounted in a vehicle and that based on at least two of the vehicle state obtained from the vehicle, the security state, and the control state, the switching processing section selects the control unit that is made to continue at least part of the functions of the software for the control unit in which an abnormality has been detected.

Furthermore, in each of the respective control units according to foregoing Embodiments, the security state indicates whether or not at least one of the functions related to the security items of two or more control units is effective.

Moreover, in the foregoing control unit according to Embodiment 3, the vehicle state may be information on the vehicle surrounding state, obtained in real time.

Furthermore, each of the respective control units according to foregoing Embodiments may be configured in such a way that the management section manages the respective security states and control states of the control unit to which the management section itself belongs and at least one of the control units other than the control unit to which the management section itself belongs.

The foregoing control apparatus according to Embodiment 3 is configured in such a way that the management section obtains the security state, the control state, and the vehicle state, before the switching processing section stars its processing.

Although the present application is described above in terms of various exemplary embodiments and implementations, it should be understood that the various features, aspects and functions described in one or more of the individual embodiments are not limited in their applicability to the particular embodiment with which they are described, but instead can be applied, alone or in various combinations to one or more of the embodiments. Therefore, an infinite number of unexemplified variant examples are conceivable within the range of the technology disclosed in the present application. For example, there are included the case where at least one constituent element is modified, added, or omitted and the case where at least one constituent element is extracted and then combined with constituent elements of other embodiments.

### INDUSTRIAL APPLICABILITY

The present disclosure can be applied to the field of a control apparatus to be mounted in a vehicle and eventually, to the field of a vehicle.

### DESCRIPTION OF REFERENCE NUMERALS

100: vehicle
200, 210: communication path
300: storage apparatus
400: first control unit
420: second control unit
440: third control unit
460: fourth control unit
500: fifth control unit
520: sixth control unit
540: seventh control unit
301, 401, 421, 501, 521: communication section
302, 404, 424, 504, 524: storage section
402, 422, 502, 522: detection section
403, 423, 503, 523: determination section
405, 425, 505, 525: management section
406, 426, 506, 526: switching processing section
407, 427, 527: calculation processing section
408, 428, 508, 528: security state
409, 429, 509, 529: control state
410, 510: vehicle state
1a, 2a, 3a, 4a, 11a, 12a, 1b, 2b, 11b, 12b: software

1-11. (canceled)

12. A control apparatus comprising two or more controllers that are connected with one another so as to be able to communicate with one another through a communication path,
wherein when an abnormality is detected in any one of the two or more controllers, another controller other than the controller in which the abnormality has been detected is made to continue at least part of functions of software for the controller in which the abnormality has been detected,
wherein each of the two or more controllers has
a communication section that performs transmission and reception of a message with another controller through the communication path,
a detection section that detects an abnormality in another controller, based on a message that has been received by the communication section from said another controller,
a management section that manages a security state and a control state of the controller to which the management section itself belongs,
a determination section that determines whether or not when the detection section detects an abnormality in said another controller, there exists necessity of making another controller other than said another in which the abnormality has been detected continue at least part of the functions of the software to be executed by said another controller in which the abnormality has been detected, and
a switching processing section that selects the controller that is made to continue at least part of the functions of the software, based on at least one of an operational requirement for the software for said another controller in which the abnormality has been detected and the security state and the control state of another controller other than said another controller in which the abnormality has been detected, when the determination section determines that the necessity of continuance exists.

13. The control apparatus according to claim 12,
wherein the two or more controllers are mounted in a vehicle,
wherein each of the two or more controllers belongs to any one of two or more functional groups of the vehicle and its operation is managed, and
wherein based on a vehicle state obtained from the vehicle, the switching processing section selects a specific functional group among the two or more functional groups and then selects, from the controllers belonging to the selected functional group, the controller that is made to continue at least part of the functions of the software.

14. The control apparatus according to claim 12, wherein the switching processing section compares respective security states and respective control states of the two or more controllers with a software operational requirement set for the software to be executed by said another controller in which the abnormality has been detected and then selects the controller that is made to continue at least part of the functions of the software.

15. The control apparatus according to claim 13, wherein the switching processing section compares respective security states and respective control states of the two or more controllers with a software operational requirement set for the software to be executed by said another controller in which the abnormality has been detected and then selects the controller that is made to continue at least part of the functions of the software.

16. The control apparatus according to claim 12, wherein the switching processing section selects the controller that is made to continue at least part of the functions of the software, based on notification received from another controller other than the controller to which the switching processing section itself belongs.

17. The control apparatus according to claim 13, wherein the switching processing section selects the controller that is made to continue at least part of the functions of the software, based on notification received from another controller other than the controller to which the switching processing section itself belongs.

18. The control apparatus according to claim 12, wherein the switching processing section can select another controller, among the two or more controllers, that is made to continue at least part of functions of software to be executed by the controller to which the switching processing section itself belongs.

19. The control apparatus according to claim 13, wherein the switching processing section can select another controller, among the two or more controllers, that is made to continue at least part of functions of software to be executed by the controller to which the switching processing section itself belongs.

20. The control apparatus according to claim 12,
wherein the two or more controllers are mounted in a vehicle, and
wherein the switching processing section selects the controller that is made to continue at least part of the functions of the software, based on at least two of a vehicle state obtained from the vehicle, the security state, and the control state.

21. The control apparatus according to claim 12, wherein the security state indicates whether or not at least one of functions related to security items of the two or more controllers is effective.

22. The control apparatus according to claim 13, wherein the security state indicates whether or not at least one of functions related to security items of the two or more controllers is effective.

23. The control apparatus according to claim 13, wherein the vehicle state is information on a surrounding state of the vehicle, obtained in real time.

24. The control apparatus according to claim 20, wherein the vehicle state is information on a surrounding state of the vehicle, obtained in real time.

25. The control apparatus according to claim 12, wherein the management section manages the respective security states and the respective control states of the controller to which the management section itself belongs and at least one of the controller other than the controller to which the management section itself belongs.

26. The control apparatus according to claim 13, wherein the management section manages the respective security states and the respective control states of the controller to which the management section itself belongs and at least one of the controllers other than the controller to which the management section itself belongs.

27. The control apparatus according to claim 13, wherein the management section obtains the security state, the control state, and the vehicle state, before the switching processing section stars its processing.

28. The control apparatus according to claim 20, wherein the management section obtains the security state, the control state, and the vehicle state, before the switching processing section stars its processing.

29. The control apparatus according to claim 24, wherein the management section obtains the security state, the control state, and the vehicle state, before the switching processing section stars its processing.

30. The control apparatus according to claim 12, wherein the controller selected by the switching processing section executes software obtained by degenerating the software for said another controller in which the abnormality has been detected.

31. The control apparatus according to claim 13, wherein the controller selected by the switching processing section executes software obtained by degenerating the software for said another controller in which the abnormality has been detected.
